(19) United States
(12) Patent Application Publication
(10) Pub. No.: US 2008/0202696 A1
(43) Pub. Date: Aug. 28, 2008

(54) Loading pallet manufacturing apparatus

(76) Inventor: Yuko Shimada, Kochi-shi (JP)

Correspondence Address: MURAMATSU & ASSOCIATES, Suite 310, 114 Pacifica, Irvine, CA, 92618, US

(21) Appl. No.: 11/709,390

(22) Filed: Feb. 22, 2007

(51) Int. Cl. B29C 65/00

(52) U.S. Cl. 156/578

(57) ABSTRACT

A loading pallet manufacturing apparatus produces loading pallets made of recyclable material with high efficiency where the loading pallet is configured by a top plate, a bottom plate, and a plurality of beams. The loading pallet manufacturing apparatus includes beam cassettes having the beams therein, chucks that retrieve and transfer the beams and place the beams on the surface of the bottom plate, plate feed rollers for transferring the top and bottom plates, glue application rollers for applying the glue to the top and bottom plates, a press for pressing the top plate and the bottom plate with the beams therebetween, thereby bonding the top plate, beams, and the bottom plate to one another.

### FIELD OF THE INVENTION

This invention relates generally to a loading pallet manufacturing apparatus, and more particularly, this invention relates to a loading pallet manufacturing apparatus that applies glue to top and bottom plates on predetermined positions so that beams are attached to the glued positions between the two plates to produce the loading pallets with high efficiency and low cost.

### BACKGROUND OF THE INVENTION

A loading pallet is a flat transport structure designed to support a variety of goods in a stable fashion while being lifted by any mobile forklift or other jacking device for loading and unloading the products. Wooden pallets and plastic pallets have been generally used in such a situation. However, recently, in order to reduce production and transportation cost as well as to achieve environmentally friendly pallets, recyclable pallets made of corrugated cardboard (paper) have been proposed. Although such loading pallets made of paper have various advantages, in manufacturing the loading pallets, there is a limitation for reducing the manufacturing time, which results in higher price and low production efficiency.

A loading pallet generally has a top plate (top board), bottom plate (bottom board), and beams. In the case of loading pallets made of paper, all of the top plate, bottom plate and the beams are made of corrugated paper. The beams are inserted between the top plate and the bottom plates. A plurality of beams are bonded to both the top plate and the bottom plate, thereby establishing a required structure as a pallet and reinforcing the pallet. The beams between the top and bottom plates also establish spaces for inserting the fork of the forklift or other loading and unloading machines.

In the process of producing such loading pallets, a pallet manufacturing apparatus applies glue to each individual beam. In case nine beams are to be used for a loading pallet, glues or adhesives must be applied to all the nine beams, which contributes to the time required for finishing the loading pallet. The glues used for such a purpose are generally hot melt adhesives, i.e., in a high temperature condition, to maintain viscosity.

Due to the nature of the high temperature glues, a heater to heat the glues or adhesives is required for the manufacturing apparatus. Moreover, the cost of the hot glues tend to be higher than other types of adhesives, such as vinyl acetate adhesives. The complexity of the operation in manufacturing the loading pallet, such as applying the heated adhesives to all of the beams, tends to complicate the structure of the pallet manufacturing apparatus.

Accordingly, there is a need of an improved pallet manufacturing apparatus which is capable of producing loading pallets in a short period of time. It is also desirable that the construction of the pallet manufacturing apparatus is simple and low cost.

### SUMMARY OF THE INVENTION

It is, therefore, an object of the present invention to provide an improved loading pallet manufacturing apparatus which is capable of producing loading pallets in shorter period of time to increase the production efficiency and decrease the production cost.

It is another object of the present invention to provide an improved loading pallet manufacturing apparatus which is capable of producing loading pallets which are made of recyclable materials such as paper.

It is a further object of the present invention to provide an improved loading pallet manufacturing apparatus which is capable efficiently applying glue to the paper plates to bond the paper plates while sandwiching a plurality of beams therebetween.

It is a further object of the present invention to provide an improved loading pallet manufacturing apparatus which is capable efficiently producing the loading pallets made of paper by incorporating beam cassettes having the beams therein and a chuck for receiving and transferring the beams to the predetermined positions.

In one aspect of the present invention, the loading pallet manufacturing apparatus includes a plate feeder which stores a plurality of top plates and bottom plates, plate feeding rollers which transfer the top plate or the bottom plate one by one to a predetermined direction, glue application mechanism which applies glue to an upper surface of the bottom plate or a lower surface of the top plate when the top plate or the bottom plate is transferred by the plate feeding rollers, a plurality of beam cassettes which store beams that will be mounted between the top plate and the bottom plate, a chuck mechanism which receives a plurality of beams and transfers the beams to predetermined locations on the bottom plate and the top plate, and a press which presses the top plate and the bottom plate while sandwiching the beams therebetween, whereby bonding the top plate, the beams and the bottom plate to one another.

In the loading pallet manufacturing apparatus of the present invention, the plate feeding rollers transfer the top plate or the bottom plate to the predetermined direction and place the top plate or the bottom plate at a predetermined position under the press.

In the loading pallet manufacturing apparatus of the present invention, the plurality of beam cassettes having the beams are loaded at a beam cassette loading area of the manufacturing apparatus and a plurality of beams are received by the chuck mechanism at the same time.

In the loading pallet manufacturing apparatus of the present invention, the plurality of beam cassettes are transferred to a beam cassette discharge area of the manufacturing apparatus when the beams are retrieved by the chuck mechanism.

In the loading pallet manufacturing apparatus of the present invention, the chuck mechanism is configured by a plurality of chucks each having a plurality of grasp portions to hold the beams and release the beams on the surface of the bottom plate.

In the loading pallet manufacturing apparatus of the present invention, the glue application mechanism is configured by a first set of glue application rollers which apply the glue to the upper surface of the bottom plate and a second set of glue application rollers which apply the glue to the lower surface of the top plate.

In the loading pallet manufacturing apparatus of the present invention, the chuck mechanism operates to receive the beams and transfers the beams while, at the same time, the plate feeding rollers transfer the bottom plate to the predetermined direction during which the glue is applied to the top surface of the bottom plate.

In the loading pallet manufacturing apparatus of the present invention, the plate feeding rollers transfer the top plate to the predetermined direction during which the glue is applied to the top surface of the bottom plate while, at the same time, the chuck mechanism operates to transfer the beams and places the beams on the surface of the bottom plate.

According to the present invention, the loading pallet manufacturing apparatus is capable of producing loading pallets in a short period of time to increase the production efficiency and decrease the production cost. The loading pallet manufacturing apparatus of the present invention produces the loading pallets which are made of recyclable materials such as paper. The loading pallet manufacturing apparatus is designed to efficiently apply the glue to the paper plates to bond the paper plates while sandwiching a plurality of beams therebetween. The loading pallet manufacturing apparatus of the present invention incorporates the beam cassettes having the beams therein and a chuck for receiving and transferring the beams to the predetermined positions on the plates under the press to produce the loading pallet at high speed.

### BRIEF DESCRIPTION OF THE DRAWINGS

FIGS. 1A-1C are schematic diagrams showing an example of structure of a loading pallet that the loading pallet manufacturing apparatus of the present invention will manufacture where FIG. 1A is a front view thereof before being assembled, FIG. 1B is a front view thereof after being assembled, and FIG. 1C is a perspective view thereof in which a top plate is disassembled.

FIG. 2 is a schematic diagram showing a front view of the pallet manufacturing apparatus of the present invention to illustrate an example of structure of the loading pallet manufacturing apparatus.

FIG. 3 is a schematic top view showing an example of structure of the loading pallet manufacturing apparatus of the present invention of FIG. 2.

FIG. 4 is a perspective view showing the chucks incorporated in the loading pallet manufacturing apparatus of the present invention for transferring the beams from beams cassettes to a space between the top plate and the bottom plate.

FIG. 5 is a perspective view showing glue application rubbers that are provided around the glue application rollers incorporated in the loading pallet manufacturing apparatus of the present invention to apply glues on predetermined positions on a paper plate.

FIG. 6 is a flow chart showing an example of basic operational steps for manufacturing the loading pallets by the loading pallet manufacturing apparatus under the present invention.

### DETAILED DESCRIPTION OF THE PREFERRED EMBODIMENT

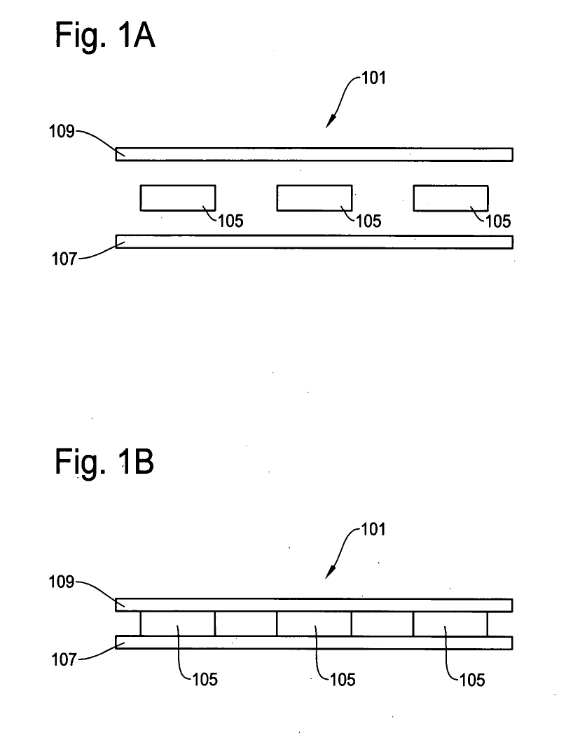

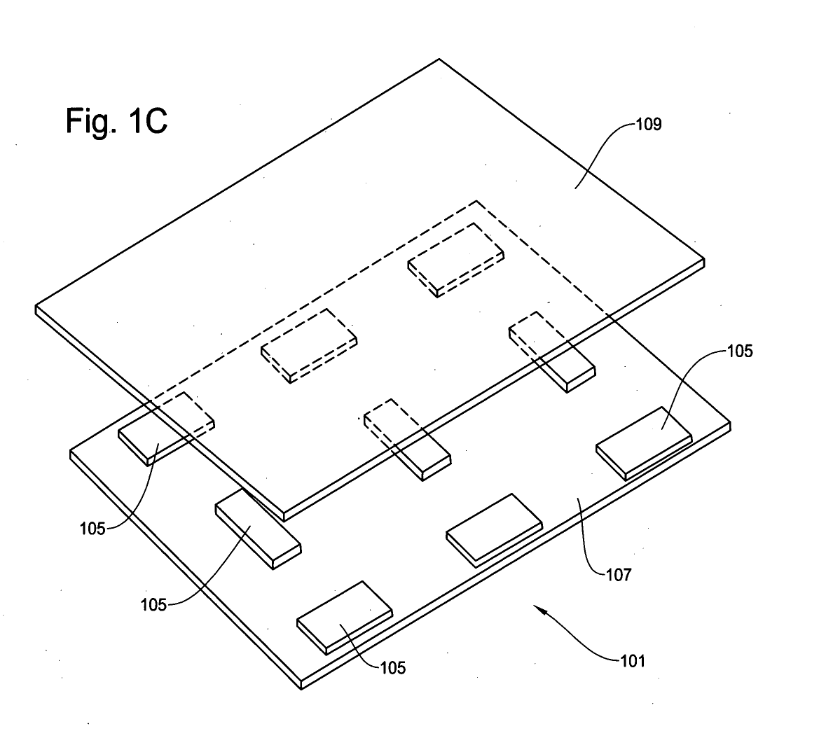

The loading pallet manufacturing apparatus of the present invention will be described in detail with reference to the accompanying drawings. FIGS. 1A, 1B and 1C show an example of structure of a loading pallet (recyclable fork sheet) 101 that the pallet manufacturing apparatus of the present invention will manufacture. In the description of the present invention, the loading pallets 101 are made of papers such as corrugated boards, although the present invention is applicable to other material as well.

As shown in the front view of FIG. 1A illustrating a disassembled state, the loading pallet 101 is mainly comprised of a bottom plate 107, a top plate 109, and beams 105. The beams 105 are placed between the top plate 109 and the bottom plate 107 at predetermined positions and bonded therebetween as shown in the front view of FIG. 1B. The beams 105 reinforce the loading pallet 101 as well as to establish a space for inserting a fork of the forklift or other loading machine.

FIG. 1C is a perspective view showing the loading pallet 101 when the top plate 109 is disassembled. The total of nine beams 105 are placed on the loading pallet 101. The beams 105 are attached to both the bottom plate 107 and top plate 109 at predetermined positions. It should be noted that the number and position of the beams 105 may be altered to satisfy requirements for which the loading pallet will be used, etc., and a specific structure of the loading pallet 101 shown in FIGS. 1A, 1B and 1C is merely an example.

The loading pallet manufacturing apparatus under the present invention is designed so that it is capable of manufacturing the loading pallets efficiently by applying glue onto predetermined positions on the top plate and the bottom plate and bonding them. Further, the loading pallet manufacturing apparatus of the present invention is designed such that an operation for applying the glue on the bottom plate or top plate can be overlapped with an operation of position the beams between the top and bottom plates. In other words, two or more operations are conducted in a parallel fashion at the same time, which decreases a production time and increases a production efficiency.

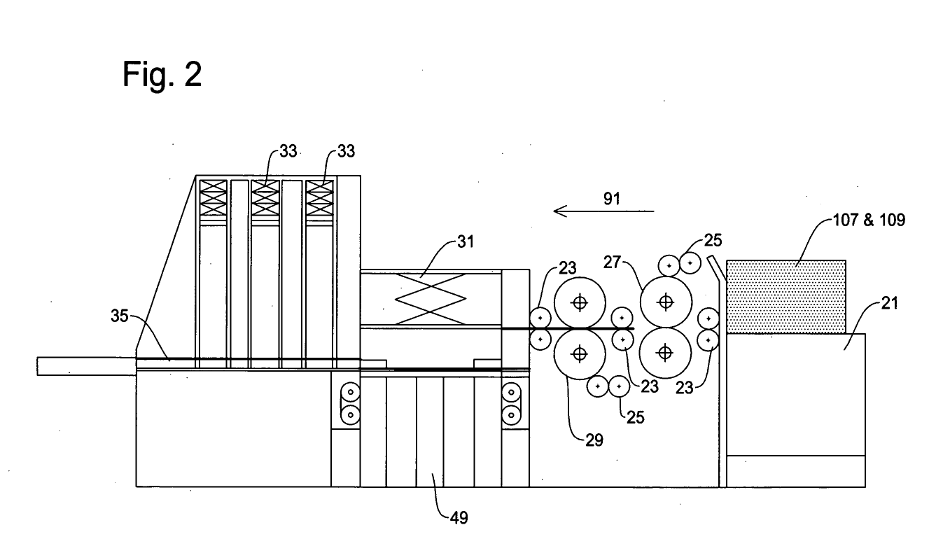

FIG. 2 is a schematic diagram showing a front view of the loading pallet manufacturing apparatus of the present invention to illustrate an example of structure of the manufacturing apparatus. In this example, the loading pallet manufacturing apparatus includes a plate feeder 21, plate feeding rollers 23, roll coaters 25, glue application rollers 27 for the bottom plate 107, glue application rollers 29 for the top plate 109, a press 31, beam cassettes 33, and a chuck 35.

The plate feeder 21 stores the plates (top plates and bottom plates) made of paper or corrugated board, for example, and feeds the plate one by one to the direction shown by the arrow 91. The top and bottom plates 107 and 109 will be provided with the glue by the glue application rollers 27 or 29 and pressed by the press 31 while the beams 105 being sandwiched therebetween. The plate feeding rollers 23 are used for guiding the top plate 109 and the bottom plate 107 one by one to the direction 91 until the plates reach the space under the press 31. The roll coaters 25 are used to provide the glue to the plate via the glue application rollers 29 and 27.

The beam cassette 33 stores the beams 105 for the loading pallets 101 in a prearranged order. The chuck 35 catches the beams from the beam cassette 33 and transports them to the bottom plate 107 under the press 31 and places the beams 105 on the surface of the bottom plate 107. The beams 105 are attached to the upper plate 109 and the bottom plate 107 when all of the components are pressed by the press 31. The roll coaters 25 receives the glue from a glue supply source (not shown) and supplies the glue to the glue application rollers 27 and 29 as will be described later.

Via the glue application roller 27 for the bottom plate 107, the glue is applied to predetermined positions on an upper surface of the bottom plate 107. Likewise, the glue is applied to predetermined positions on a lower surface of the top plate 109 by the glue application roller 29. In the preferred embodiment, vinyl acetate adhesives are used as the glue, which allows a high speed operation of the pallet manufacturing apparatus compared to the case of using hot melt adhesives. Although the material for the loading pallet 101 that the loading pallet manufacturing apparatus will produce is corrugated cardboard in the present description, the loading pallet manufacturing apparatus under the present invention can use other material such as honeycomb fiberboard, solid fiberboard, etc., and molded pulp may also be used.

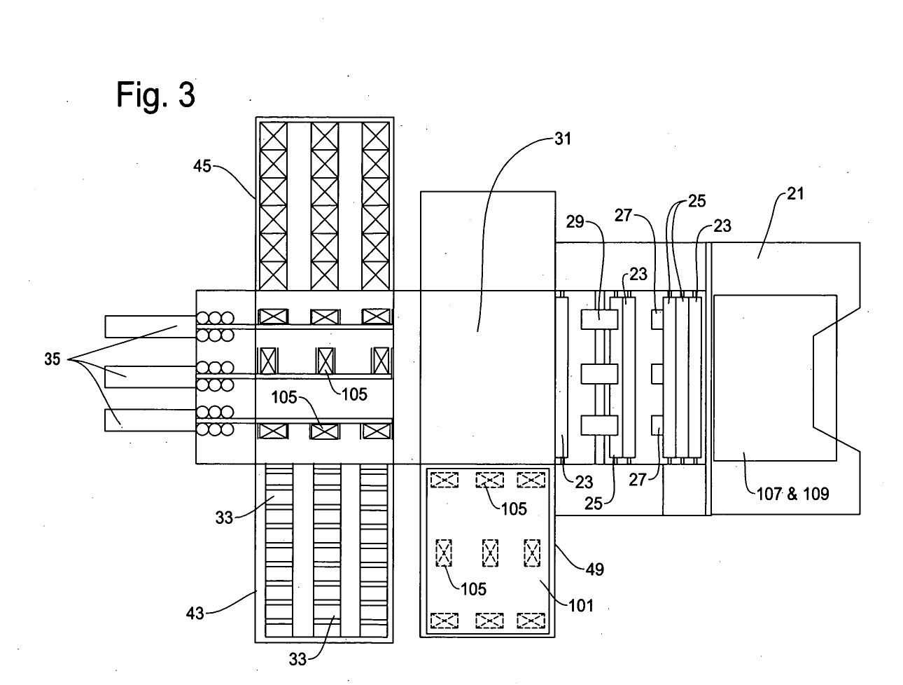

FIG. 3 is a top view showing the pallet manufacturing apparatus corresponding to that of FIG. 2. In the top view, the plate feeder 21, the plate feed rollers 23, the roll coaters 25, the glue application roller 27 for the bottom plates 107, the glue application roller 29 for the top plates 109, the press 31, the beam cassettes 33, and the chucks 35 are shown. The pallet manufacturing apparatus in FIG. 3 further shows a beam cassette discharge area 43, a beam cassette loading area 45, and a finished product unloading area 49.

The beam cassette discharge area 43 is to temporarily store the emptied beam cassettes 33 for unloading therefrom so that the beams 105 will be mounted in the beam cassettes 33 for the next use. Such beam cassettes 33 having the beams 105 are loaded in the beam cassette loading area 45 so that the chucks 35 retrieve the beams 105 from the beam cassettes 33 to transfer them to the space between the top plate 109 and the bottom plate 107. The loading palettes 101 produced by the pallet manufacturing apparatus are collected at the finished product unloading area 49 and unloaded therefrom for shipment, etc.

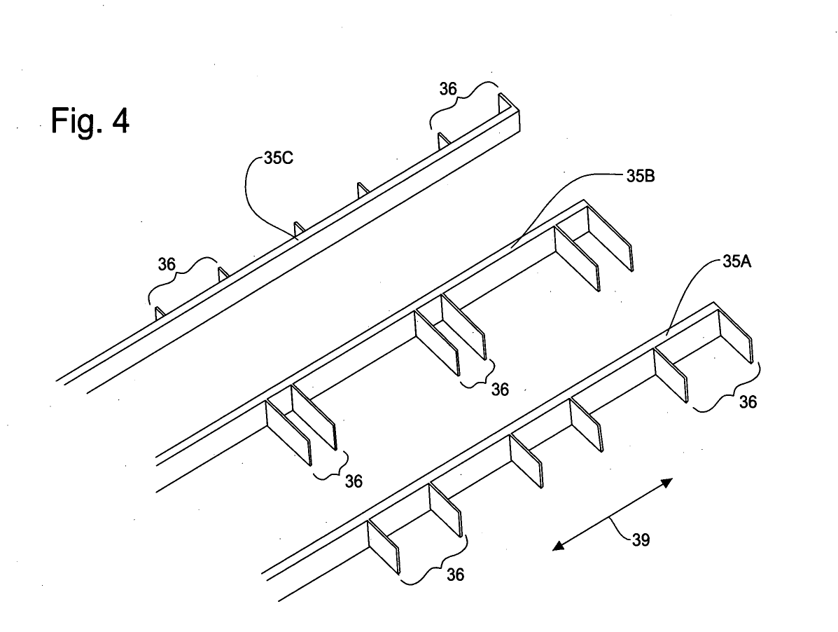

FIG. 4 is a perspective view showing the chucks 35 for retrieving the beams 105 from the beam cassettes 33 and transferring the beams 105 to the space between the top plate 109 and the bottom plate 107. In this example, three chucks 35 are used to hold the beams 105 and position the beams 105 between the top plate 109 and the bottom plate 107. In this example, the chucks 35 include a right chuck 35A, a middle chuck 35B, and a left chuck 35C.

Each of the chucks 35 has grabbing portions 36 that are configured to cover the size of the beams 105 for retrieving the beams 105 from the beam cassettes 33. As noted above, the beam cassettes 33 having the beams 105 are stacked at the beam cassette loading area 45. Thus, the chucks 35 receive the beams 105 from the beam cassettes 33 at the lowest position, for example, in the beam cassette loading area 45 and transfer the beams 105 in the direction indicated by an arrow 39 to position the beams 105 between the top plate 109 and the bottom plate 107.

As shown in the top view of FIG. 2, each of the chucks 35 catches a plurality of the beams 105 that are placed in the beam cassettes 33. The chucks 35 transfer the beams 105 toward the press 31 and placed at the position between the top plate 109 and the bottom plate. The press 31 pushes the top plate 109 toward the bottom plate 107 thereby bonding the top plate 109, the beams 105 and the bottom plate 107 with one another.

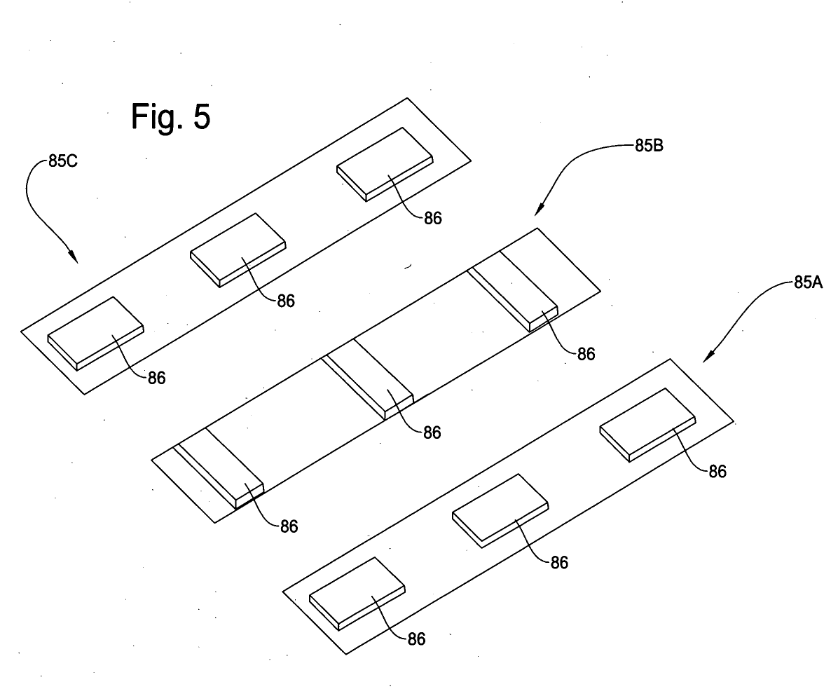

FIG. 5 is a perspective view showing an example of structure of glue transfer rubbers 85 used for the glue application rollers 27 and 29 of the loading pallet manufacturing apparatus. Typically, the glue transfer rubbers 85 are mounted on the surface of the glue application rollers 27 and 29. Each of the glue transfer rubbers 85 includes a plurality of rubber portions 86 which are formed at predetermined locations and shaped and sized such that the rubber portions 86 will make contact with the predetermined positions on the top and bottom plates 107 and 109. Although the rubber is used, it should be noted that other flexible material can also be used as the rubber portions 86 on the glue transfer rubber 85.

In this example, the glue transfer rubbers 85 include a right glue transfer rubber 85A, a middle glue transfer rubber 85B, and a left glue transfer rubber 85C. These glue transfer rubbers 85 receive the glue from the roll coaters 25 shown in FIGS. 2 and 3. The right glue transfer rubber 85A applies the glue to the right side beams 105, the middle glue transfer rubber 85B applies the glue to the middle beams 105, and the left glue transfer rubber 85C applies the glue to the left side beams.

The size and placement of the glue transfer rubbers 85 can vary depending on the configuration of the loading pallets 101, especially, the size and position of the beams 105 to be bonded. In FIG. 2, as the glue application rollers 27 having the glue transfer rubbers 85 rotates, the glue on the rubber portions 86 are applied to the predetermined locations on an upper surface of the bottom plate 107. Similarly, as the glue application rollers 29 having the glue transfer rubbers 85 rotates, the glue on the rubber portions 86 are applied to the predetermined locations on a lower surface of the top plate 109.

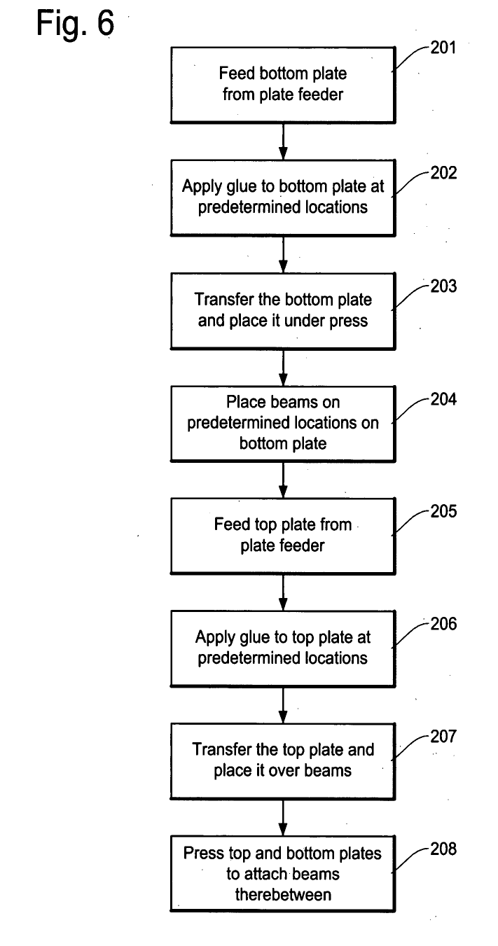

FIG. 6 is a flow chart showing the basic steps of manufacturing the loading pallets by the loading pallet manufacturing apparatus of the present invention. As a manufacturing procedure starts, a bottom plate 107 is fed from the plate feeder 21 in the step 201, which stores a plurality of plates. In the foregoing, although reference has been made separately to the top plate 109 and the bottom plate 107, they are actually the identical plates with the same material, size and shape. Prior to the start of the manufacturing process, a large number of top and bottom plates are stacked in the plate feeder 21.

The plate feed rollers 23 advance the bottom plate 107 from the plate feeder 21 in the direction of arrow 91 in FIG. 2. The glue is applied from the roll coaters 25 to the glue transfer rubbers 85 on the glue application rollers 27. Thus, in the step 202, the glue is attached to an upper surface of the bottom plate 107 at the predetermined locations when the bottom plate 107 passes through the glue application rollers 27. In the step 203, the plate feed rollers 23 transfer the bottom plate 107 forward and place it in a space under the press 31.

Simultaneously with or slightly delayed by the operation of the plate feed rollers 23 and the glue application rollers 27, the beams 105 for the loading pallet 101 are carried by the chucks 35 so that they are placed on the upper surface of the bottom plate 107 in the step 204. In the example shown in FIG. 1 where nine beams 105 are provided to one sheet of the loading pallet 101, the chucks 35 transfer all of the nine beams 105 simultaneously over the bottom plate 107 under the press 31. Then, the chucks 35 release the beams 105 on the bottom plate at the locations where the glue is applied.

Since the chucks 35 are arranged to have the grasp portions spaced so as to correspond to the beam placement location on the bottom plate 107, the chucks 35 move horizontally to a predetermined position calculated to fit the beams 105 over the bottom plate 107. The chucks 35 then drop the beams 105 on the bottom plate 107 by opening or loosening the grasp portions. After releasing the beams 105, the chucks 35 return to the original position to receive the next set of beams 105.

Simultaneously with or slightly delayed by the operation of the chucks 35 for transferring the beams 105 as noted above, in the step 205, the plate feed rollers 23 advance the top plate 107 from the plate feeder 21 in the direction of arrow 91 in FIG. 2. The glue is applied from the roll coaters 25 to glue transfer rubbers 85 on the glue application rollers 29. Thus, in the step 206, the glue is attached to a lower surface of the top plate 109 at the predetermined locations when the top plate 109 passes through the glue application rollers 29.

In the step 207, the plate feed rollers 23 transfer the top plate 107 and place it on the beams 105 that have been placed on the bottom plate 107 in the foregoing steps. The glued positions of both the top plate 109 and the bottom plate 107 are aligned to correspond with one another at which the beams are provided by the chucks 35 noted above. In the step 208, the press 31 presses the top plate 109 and the bottom plate 107 while sandwiching the beams 105 between the top and bottom plates to bond all of the members, thereby producing the loading pallet 101.

As loading pallets 101 are manufactured, the finished loading pallets 101 are accumulated at the finished product unloading area 49 as shown in the top view of FIG. 3. When a predetermined number of manufactured loading pallets 101 are collected at the finished product unloading area 49, the loading pallets 101 may be removed from the unloading area 49 for shipment, storage, etc. When the beam cassettes 33 become empty, they are removed to the beam cassette discharge area 43. The beams 105 are mounted on the empty beam cassettes 33 again and the beam cassettes 33 are loaded in the beam cassette loading area 45 for use in the next manufacturing operation.

The steps described above are repeated to manufacture the desired number of loading pallets 101. As shown, the speed of manufacturing the loading pallets 101 is improved by applying the glue on the top and bottom plates at predetermined locations as opposed to applying the glue to each of the beams. Further, the operation of the chucks 35 need not wait until the operation of applying the glue to the bottom plate 107 will be completed, i.e., the both operations can be conducted substantially simultaneously. Further, the operation of applying the glue to the top plate 107 need not wait until the operation of the chucks 35 will be completed, i.e., the both operations can be conducted substantially simultaneously. Therefore, the loading pallets 101 can be produced at high speed and low cost.

As has been described in the foregoing, according to the present invention, the loading pallet manufacturing apparatus is capable of producing loading pallets in a short period of time to increase the production efficiency and decrease the production cost. The loading pallet manufacturing apparatus of the present invention produces the loading pallets which are made of recyclable materials such as paper. The loading pallet manufacturing apparatus is designed to efficiently apply the glue to the paper plates to bond the paper plates while sandwiching a plurality of beams therebetween. The loading pallet manufacturing apparatus of the present invention incorporates the beam cassettes having the beams therein and a chuck for receiving and transferring the beams to the predetermined positions on the plates under the press to produce the loading pallet at high speed.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A loading pallet manufacturing apparatus for producing loading pallets, comprising:
a plate feeder which stores a plurality of top plates and bottom plates;
plate feeding rollers which transfer the top plate or the bottom plate one by one to a predetermined direction;
glue application mechanism which applies glue to an upper surface of the bottom plate or a lower surface of the top plate when the top plate or the bottom plate is transferred by the plate feeding rollers;
a plurality of beam cassettes which store beams that will be mounted between the top plate and the bottom plate;
a chuck mechanism which receives a plurality of beams and transfers the beams to predetermined locations on the bottom plate and the top plate; and
a press which presses the top plate and the bottom plate while sandwiching the beams therebetween, whereby bonding the top plate, the beams and the bottom plate to one another.

2. A loading pallet manufacturing apparatus as defined in claim 1, wherein said plate feeding rollers transfer the top plate or the bottom plate to the predetermined direction and place the top plate or the bottom plate at a predetermined position under the press.

3. A loading pallet manufacturing apparatus as defined in claim 1, wherein said plurality of beam cassettes having the beams are loaded at a beam cassette loading area of the manufacturing apparatus and a plurality of beams are received by the chuck mechanism at the same time.

4. A loading pallet manufacturing apparatus as defined in claim 3, wherein said plurality of beam cassettes are transferred to a beam cassette discharge area of the manufacturing apparatus when the beams are retrieved by the chuck mechanism.

5. A loading pallet manufacturing apparatus as defined in claim 3, wherein said chuck mechanism is configured by a plurality of chucks each having a plurality of grasp portions to hold the beams and release the beams on the surface of the bottom plate.

6. A loading pallet manufacturing apparatus as defined in claim 1, wherein said glue application mechanism is configured by a first set of glue application rollers which apply the glue to the upper surface of the bottom plate and a second set of glue application rollers which apply the glue to the lower surface of the top plate.

7. A loading pallet manufacturing apparatus as defined in claim 1, wherein said chuck mechanism operates to receive the beams and transfers the beams while, at the same time, said plate feeding rollers transfer the bottom plate to the predetermined direction during which the glue is applied to the top surface of the bottom plate.

8. A loading pallet manufacturing apparatus as defined in claim 1, wherein said plate feeding rollers transfer the top plate to the predetermined direction during which the glue is applied to the top surface of the bottom plate while, at the same time, said chuck mechanism operates to transfer the beams and places the beams on the surface of the bottom plate.
